(19) United States
(12) Patent Application Publication
(10) Pub. No.: US 2016/0116119 A1
(43) Pub. Date: Apr. 28, 2016

(54) LED LIGHT CORE STRUCTURE

(71) Applicant: EDISON OPTO CORPORATION, New Taipei City (TW)

(72) Inventors: Chien-Jung WU, New Taipei City (TW); Shang-Hsun TSAI, New Taipei City (TW); Han-Pin PAN, New Taipei City (TW)

(21) Appl. No.: 14/659,923

(22) Filed: Mar. 17, 2015

(30) Foreign Application Priority Data
Oct. 23, 2014 (TW) 103136721

(51) Int. Cl. F21K 99/00

(52) U.S. Cl. CPC F21K 9/17; F21K 9/135

(57) ABSTRACT

An LED light core structure, which has better mechanical strength and good heat dissipation effect and is able to 360-degree project light. The LED light core structure includes a metal-made substrate having at least two faces. The substrate is formed with multiple openings communicating the two faces. At least one lug is connected with an edge of each opening. The lug is bent from one of the faces and extends outward from one of the faces. An LED is disposed on the lug, whereby the light of the LED is projected to one of the faces and the other opposite face through the opening. The substrate is unlikely to crack so that the ratio of good products is increased. The substrate can provide excellent heat dissipation effect for the LED. Due to the openings, the LED light core can project light to both sides of the substrate.

### FIELD OF THE INVENTION

The present invention relates generally to a technique concerning fluorescent lamp tube, incandescent bulb and LED, and more particularly to an LED light core structure, which can be used to replace the conventional fluorescent lamp tube and the wolfram filament electrodes of the incandescent bulb. The LED light core structure includes a metal-made substrate and multiple LED mounted on the surfaces of the substrate.

### BACKGROUND OF THE INVENTION

Currently, the illumination of homes, offices, classrooms and factories are mostly provided by fluorescent lamp tubes. In use, the incandescent bulbs are not such convenient as the fluorescent lamp tubes. However, the incandescent bulbs are still used in many situations to help in illumination as necessary. The fluorescent lamp tube is a glass tube body containing therein mercury and argon. Wolfram filament electrodes are sealed in the light caps at two ends of the tube body. After powered on, the wolfram filament electrodes can emit ultraviolet ray to energy the fluorescent powder coated on the inner wall face of the tube body so as to emit visible light. With respect to the incandescent bulb, the wolfram filament is sealed in the glass bulb. After powered, the wolfram filament is heated and incandesced to emit visible light. The prices of the fluorescent lamp tube and the incandescent bulb are both not very high. However, when the light core structure formed of the wolfram filament is powered on to emit light, the light core structure will consume quite a lot of electricity. Moreover, the mercury contained in the fluorescent lamp tube will contaminate the environment.

Therefore, from the viewpoint of energy saving and environmental protection, adoption of light-emitting diode (LED) is a very good substitution option for the conventional fluorescent lamp tube and incandescent bulb. However, before using the LED light to fully replace the incandescent bulb and fluorescent lamp tube, a problem must be overcome. That is, in the conventional LED light core structure, the LEDs are disposed on a printed circuit board. The printed circuit board is nontransparent. Therefore, in the case that the LEDs are disposed on the same face of the printed circuit board, the LED can only project light in one single direction without the possibility of 360-degree illumination. In the case that the LEDs are arranged on both faces of the printed circuit board, a 360-degree illumination effect can be achieved. However, the cost for the LED light core structure will be increased. Moreover, the light emitted from the LED on one face of the printed circuit board cannot pass through the printed circuit board to the other face thereof. Under such circumstance, the energy is wasted.

In view of the above, an improved LED light core structure has been developed. In the LED light core structure, the LEDs are disposed on a transparent substrate made of sapphire. The LEDs are arranged on one face of the sapphire substrate and the anodes and cathodes of the LEDs are connected to outer side of the LED light via fine metal leads for connecting with a power supply to power the LEDs. The light emitted from the LEDs can pass through the sapphire substrate to illuminate both sides of the sapphire substrate and achieve a 360-degree illumination effect.

However, in manufacturing, transfer and use process of the LED light core, the sapphire substrate is very likely to crack and break. Therefore, the ratio of good products is lowered. Moreover, the sapphire substrate has relatively poor heat conductivity. Therefore, the sapphire substrate can hardly provide good heat dissipation effect for the LED. As a result, the LED often burns down due to overheating. Accordingly, the reliability of the product is unstable. In addition, the sapphire substrate is an electrical insulator. Therefore, it is necessary to add metal electrodes to the positive and negative electrodes. It often takes place that the metal electrodes detach from the sapphire substrate. This further lowers the ratio of good products in the manufacturing process.

It is therefore tried by the applicant to provide an LED light core structure to overcome the above problems of the conventional LED light core structure.

### SUMMARY OF THE INVENTION

It is therefore a primary object of the present invention to provide an LED light core structure, which has better mechanical strength and good heat dissipation effect and is able to 360-degree project light. The LED light core structure can be used to replace the conventional fluorescent lamp tube and the wolfram filament electrodes of the incandescent bulb. In contrast, the conventional sapphire substrate has poor heat dissipation effect and is likely to crack. The LED light core structure of the present invention overcomes the above problems of the conventional sapphire substrate. Moreover, the LED light core structure of the present invention is able to 360-degree project light.

To achieve the above and other objects, the LED light core structure of the present invention includes a metal-made substrate having at least two faces. The substrate is formed with multiple openings communicating the two faces. At least one lug is connected with an edge of each opening. The lug is bent from one of the faces and extends outward from one of the faces. An LED is disposed on the lug, whereby the light of the LED is projected to one of the faces and the other opposite face through the opening.

In the above LED light core structure, the opening communicates the two faces of the substrate. Therefore, when the LED disposed on the lug of one of the faces of the substrate emits light, not only one of the faces is illuminated, but also the other face of the substrate is illuminated through the opening. Accordingly, the LED can provide 360-degree illumination effect. The substrate can be made of metal material. The metal substrate can be punched to form the openings and lugs without easy cracking and breakage. Therefore, the ratio of good products can be increased. Moreover, the heat generated by the LED can be efficiently dissipated. In contrast, the conventional sapphire substrate is likely to crack and break and has poor heat dissipation effect. The present invention overcomes the above problems of the conventional sapphire substrate. Moreover, the present invention is able to project light to two sides of the substrate. Therefore, the conventional fluorescent lamp tube and the wolfram filament electrodes of the incandescent bulb can be directly replaced with the present invention to break through the limitation of the conventional LED lighting angle.

In the above LED light core structure, the substrate is disposed in a light tube. A light cap is disposed at each of two ends of the light tube. The light cap has two conductive terminals electrically connected to the LED.

In the above LED light core structure, the two conductive terminals of the light cap are respectively positioned on the two opposite faces of the substrate.

In the above LED light core structure, the substrate can be alternatively disposed in a bulb. Accordingly, the LED light core structure is applicable to the existent specification of the conventional fluorescent lamp tube and incandescent bulb. Therefore, the conventional light core structure formed of the wolfram filament of the incandescent bulb can be directly replaced with the present invention.

In the above LED light core structure, the multiple lugs are arranged on the substrate at equal intervals or unequal intervals to form a light bar or light string.

In the above LED light core structure, the multiple lugs are positioned on the same face of the substrate or respectively positioned on the different faces of the substrate.

In the above LED light core structure, the extending direction of the lug is normal to the faces of the substrate or inclined from the faces of the substrate. The lugs are parallel to each other or unparallel to each other. Accordingly, the illumination angle of the LED can be changed in accordance with the requirements to provide various illumination forms.

### BRIEF DESCRIPTION OF THE DRAWINGS

The present invention can be best understood through the following description and accompanying drawings, wherein:

FIG. 1 is a perspective view of a first embodiment of the present invention;

FIG. 2 is a sectional view of a part of FIG. 1;

FIG. 3 is a perspective view according to FIG. 1, showing the first embodiment of the present invention in another aspect;

FIG. 4 is a sectional view of a part of FIG. 3;

FIG. 5 is a perspective view according to FIG. 1, showing the first embodiment of the present invention in still another aspect;

FIG. 6 is a sectional view of a part of FIG. 5;

FIG. 7 is a perspective view according to FIG. 1, showing the first embodiment of the present invention in still another aspect; and

FIG. 8 is a perspective view of a second embodiment of the present invention.

### DETAILED DESCRIPTION OF THE PREFERRED EMBODIMENTS

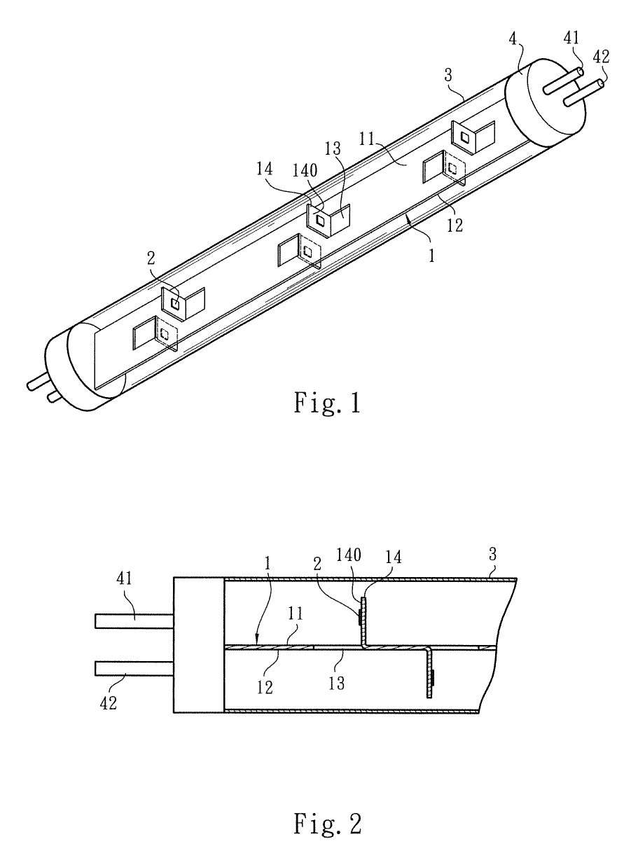

Please refer to FIGS. 1 and 2, which show a first embodiment of the present invention. The LED light core structure of the present invention includes an elongated substrate 1 having at least two faces 11, 12. The substrate 1 is formed with multiple openings 13 communicating the two faces 11, 12. The opening 13 can have a rectangular form. At least one rectangular lug 14 is connected with the edge of each opening 13. The lug 14 is bent from the face 11 or 12 and extends outward from the face 11 or 12. Accordingly, the multiple lugs 14 are respectively positioned on the two faces 11, 12 of the substrate 1. The extending direction of the lug 14 is normal the faces 11, 12 of the substrate 1. The openings 13 are arranged on the substrate 1 at equal intervals or unequal intervals. Accordingly, the lugs 14 are arranged on the two faces 11, 12 of the substrate 1 at equal intervals or unequal intervals. The adjacent lugs 14 can be parallel to each other or unparallel to each other.

As shown in the drawings, each lug 14 has a plane face 140. At least one LED 2 is located on the plane face 140. The light of the LED 2 is projected to both the face 11 and the opposite face 12 through the opening 13. That is, the LED 2 can emit light through the opening 13 to outer sides of the two faces 11, 12 of the substrate 1. Moreover, the plane faces 140 are directed in the arrangement direction of the lugs 14, whereby the LED 2 are arranged on the substrate 1 to form a light bar or light string.

As shown in FIG. 1, the substrate 1 can be disposed in a glass light tube 3. A metal light cap 4 is disposed at each of two ends of the light tube 3. The light cap 4 has two conductive terminals 41, 42 electrically connected to the LED 2. FIG. 2 more clearly shows that the two conductive terminals 41, 42 of the light cap 4 are respectively positioned on the two opposite faces 11, 12 of the substrate 1.

According to the above arrangement, the opening 13 communicates the two faces 11, 12 of the substrate 1. Therefore, when the LED 2 disposed on the lug 14 of one of the faces 11, 12 of the substrate 1 emits light, not only one of the faces 11, 12 is illuminated, but also the other face of the substrate 1 is illuminated through the opening 13. Accordingly, the LED 2 can provide 360-degree illumination effect.

It should be noted that the two conductive terminals 41, 42 of the light cap 4 are respectively positioned on the two opposite faces 11, 12 of the substrate 1. Therefore, after the light tube 3 is installed on a light holder (not shown) of a ceiling, the two faces 11, 12 of the substrate 1 and the LED 2 on the two faces 11, 12 are right directed to two sides of the light holder. In this case, the LED 2 on one of the faces 11, 12 of the substrate 1 will not be directed to the ceiling. Accordingly, the LED 2 on both faces 11, 12 of the substrate 1 can emit light to fully illuminate an area under the ceiling.

Accordingly, the substrate 1 can be made of metal material. The metal substrate 1 can be punched to form the openings 13 and lugs 14 without easy cracking and breakage. Therefore, the ratio of good products can be increased. Moreover, the heat generated by the LED 2 can be efficiently dissipated. In contrast, the conventional sapphire substrate is likely to crack and break and has poor heat dissipation effect. The present invention overcomes the above problems of the conventional sapphire substrate. Moreover, the present invention is able to project light to two sides of the substrate 1. Therefore, the conventional fluorescent lamp tube and the wolfram filament electrodes of the incandescent bulb can be directly replaced with the present invention to break through the limitation of the conventional LED lighting angle.

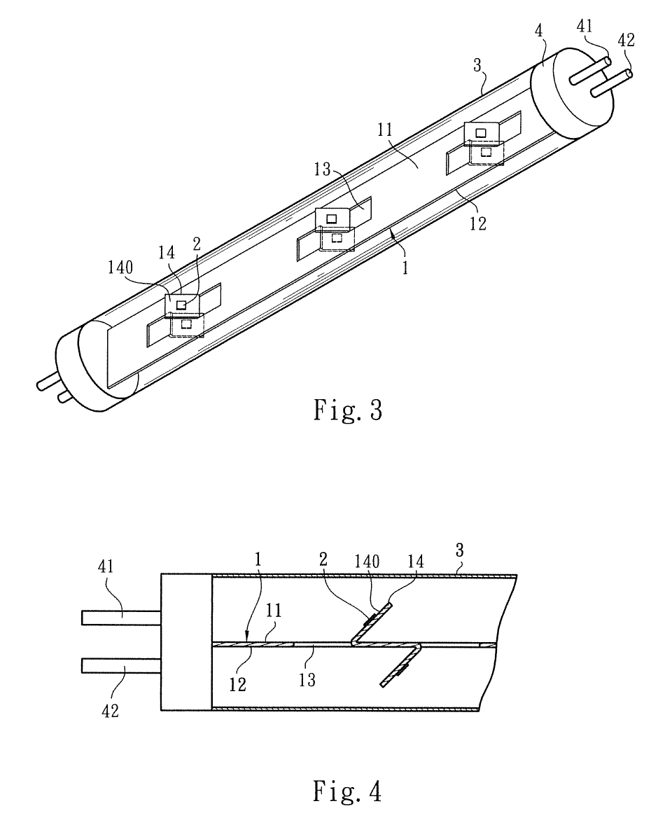

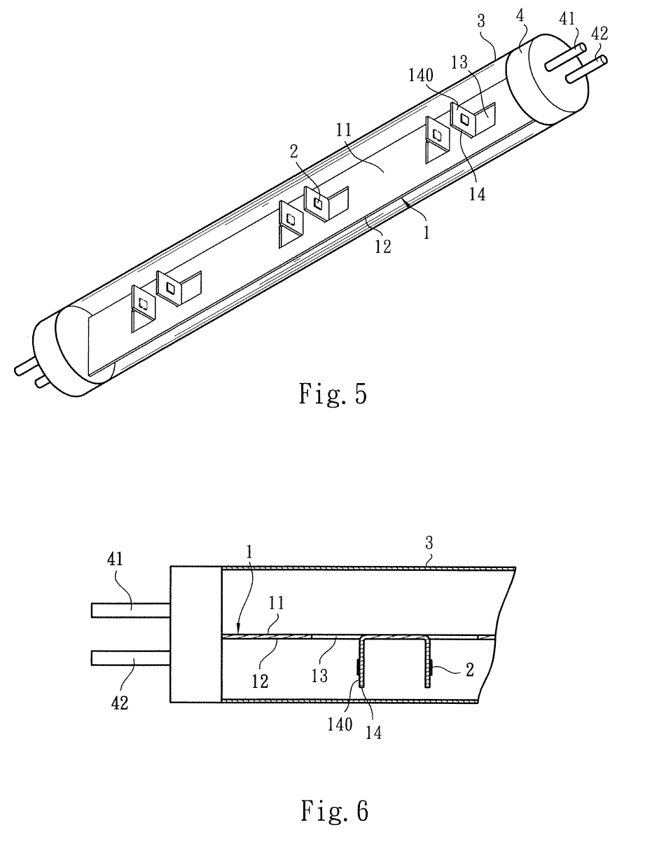

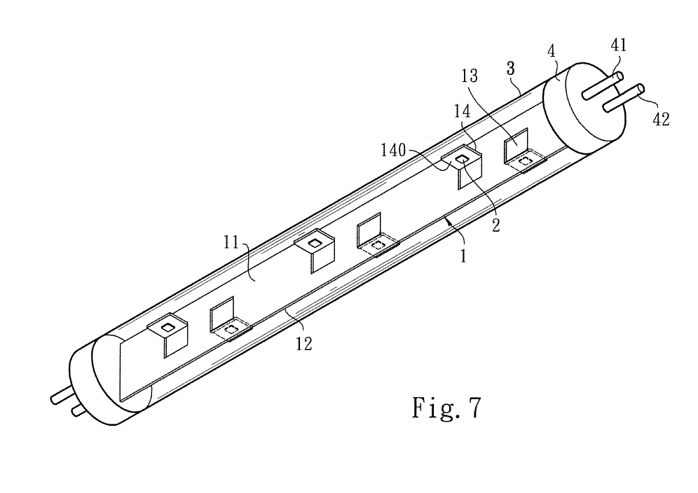

Please now refer to FIGS. 3 and 4. In a preferred embodiment, the extending direction of the lug 14 is inclined from the two faces 11, 12 of the substrate 1. Referring to FIGS. 5 and 6, in another embodiment, the multiple lugs 14 are alternatively positioned on the same face 11 or 12 of the substrate 1. FIG. 7 shows still another embodiment in which the plane face 140 is directed in a direction normal to the arrangement direction of the lugs 14. Accordingly, the illumination angle of the LED 2 can be changed in accordance with the requirements to provide various illumination forms.

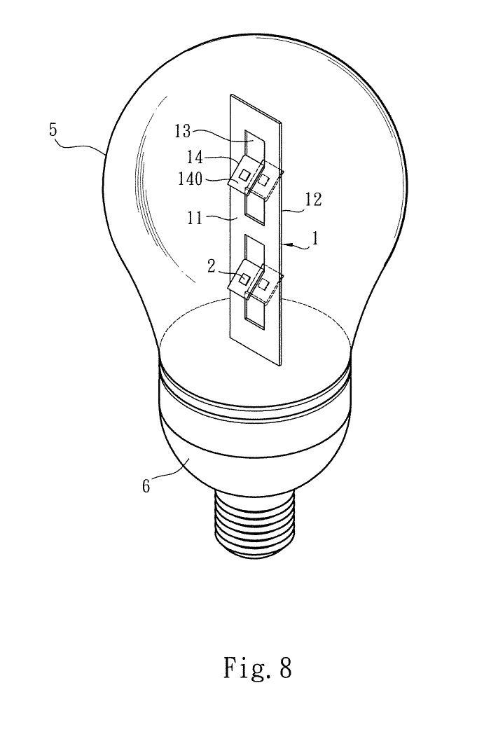

Please refer to FIG. 8. The substrate 1 can be alternatively disposed in a glass bulb 5. One end of the substrate 1 is connected with a light cap 6 at the bottom of the bulb 5, whereby the LED 2 on the substrate 1 are electrically connected with the light cap 6. According to the above arrangement, the LED light core structure formed of the metal substrate 1 has better mechanical strength and good heat dissipation effect. Moreover, the LED light core structure is able to 360-degree project light and is applicable to the existent specification of the conventional fluorescent lamp tube and incandescent bulb. Therefore, the conventional light core structure formed of the wolfram filament of the incandescent bulb can be directly replaced with the present invention to save energy and meet the requirement of environmental protection.

The above embodiments are only used to illustrate the present invention, not intended to limit the scope thereof. Many modifications of the above embodiments can be made without departing from the spirit of the present invention.

What is claimed is:

1. An LED light core structure comprising a substrate having at least two faces, the substrate being formed with multiple openings communicating the two faces, at least one lug being connected with an edge of each opening, the lug being bent from one of the faces and extending outward from one of the faces, an LED being disposed on the lug, whereby the light of the LED is projected to one of the faces and the other opposite face through the opening.

2. The LED light core structure as claimed in claim 1, wherein the substrate is disposed in a light tube, a light cap being disposed at each of two ends of the light tube, the light cap having two conductive terminals electrically connected to the LED.

3. The LED light core structure as claimed in claim 2, wherein the two conductive terminals of the light cap are respectively positioned on the two opposite faces of the substrate.

4. The LED light core structure as claimed in claim 1, wherein the substrate is disposed in a bulb.

5. The LED light core structure as claimed in claim 1, wherein the multiple lugs are arranged on the substrate at equal intervals.

6. The LED light core structure as claimed in claim 1, wherein the multiple lugs are arranged on the substrate at unequal intervals.

7. The LED light core structure as claimed in claim 1, wherein the multiple lugs are positioned on the same face of the substrate.

8. The LED light core structure as claimed in claim 1, wherein the multiple lugs are respectively positioned on the different faces of the substrate.

9. The LED light core structure as claimed in claim 1, wherein an extending direction of the lug is normal to the faces of the substrate.

10. The LED light core structure as claimed in claim 1, wherein an extending direction of the lug is inclined from the faces of the substrate.

11. The LED light core structure as claimed in claim 1, wherein the lugs are parallel to each other.

12. The LED light core structure as claimed in claim 1, wherein the lugs are unparallel to each other.

13. The LED light core structure as claimed in claim 1, wherein the substrate is made of metal material.
